(19) United States
(12) Patent Application Publication
(10) Pub. No.: US 2019/0070671 A1
(43) Pub. Date: Mar. 7, 2019

(54) METHOD FOR MACHINING A WORKPIECE, TOOL HEAD FOR A LATHE, AND LATHE

(71) Applicant: J.G. WEISSER SÖHNE GMBH & CO. KG, St. Georgen (DE)

(72) Inventors: Thorsten Rettich, Konigsfeld (DE); Reiner Jorg, Schramberg (DE)

(73) Assignee: J.G. Weisser Söhne GmbH & Co. KG, St. Georgen (DE)

(21) Appl. No.: 16/072,958

(22) PCT Filed: Jan. 16, 2017
(86) PCT No.: PCT/EP2017/000040

§ 371 Date: Jul. 26, 2018

(30) Foreign Application Priority Data
Jan. 27, 2016 (DE) 10 2016 000 841.5

(51) Int. Cl. B23B 29/12; B23B 5/02; B23B 29/20

(52) U.S. Cl. CPC B23B 29/125; B23B 2260/108; B23B 29/20; B23B 5/02

(57) ABSTRACT

A method for machining a workpiece and a lathe are provided, as well a tool head (1) for a lathe (2), having a tool holder (5) retaining a machining tool (3), wherein the tool head (1) has at least one actuator (6) for generating an additional movement of the tool holder (5) in the form of an oscillating pivoting movement about at least one pivot axis (7)

### BACKGROUND

The invention relates to a method for machining a workpiece with the aid of a material-removing machining tool having a cutting edge, wherein the workpiece is driven in rotation in order to generate a cutting movement and the cutting edge of the machining tool comes into cutting engagement with the workpiece, and in the case of which the machining tool is moved by a defined advancement movement, wherein the advancement movement is accompanied by an oscillating additional movement of the cutting edge of the machining tool.

The invention also relates to a tool head for a lathe, having a tool holder retaining a machining tool, in particular one with at least one cutting edge, and to a lathe having an operating spindle for driving in rotation a workpiece which is to be machined by turning, having a tool turret, and having at least one tool head fitted on the tool turret.

A wide variety of different embodiments of such methods, tool heads, and lathes are known from the prior art.

In the case of a known method, the so-called face turning of surfaces of workpieces, for example of plate-shaped parts, a cutting edge of the machining tool and the rotating workpiece are moved relative to one another, wherein the advancement movement takes place essentially perpendicularly to the axis of rotation of the workpiece. The machining tool here cuts a helical indentation into the workpiece surface which is to be machined. The pitch of the helix and the depth of the roughness of the machined surface are greater or smaller in dependence on the advancement speed, cutting speed and cutting depth.

For many applications, it is desirable to generate the smallest possible roughness depth and also a twist-free surface, that is to say a surface which is as planar and smooth as possible. An important application is, for example, the machining of brake disks in order to produce braking surfaces on the brake disks. Irregularities in the braking surface produced, caused by a turning-induced helix, may result in brake linings which interact with the braking surface being “drawn in” in the direction of an axial center of a vehicle equipped with such brake disks. This can result in increased forces in the region of the chassis of the vehicle. It is additionally possible, when use is made of such brake disks, for the brake disks, inter alia also to squeak and judder during braking operation, which can adversely affect, on the one hand, the driving comfort and, on the other hand, also driver safety.

These problems can be reduced by special machining of the brake disk, for example by so-called precision turning. Precision turning makes use of improved cutting-edge materials and more precise machine tools, as well as smaller cutting depths and smaller amounts of advancement, which can reduce formation of the indentations. It is also the case here, however, that a helix surface structure cannot be eliminated altogether, or this can only be achieved with a comparatively high level of outlay.

It is also known for the braking surfaces of brake disks, following turning, to be finished off by so-called cross grinding. The introduction of cross grinding in the braking surfaces of the brake disks, however constitutes an additional machining operation, which can significantly increase the outlay required for producing the brake disks. In addition, such follow-up machining can give rise to an undefined surface which, in some circumstances, can be associated with further, or different, disadvantages.

German Utility Model 203 03 204 U1 discloses a lathe in which, during the face turning of the workpiece surface, the advancement movement of the workpiece and cutting tool relative to one another is accompanied by an oscillating vibration movement in the advancement direction. The oscillating vibration movements are generated by oscillating advancement movements of a tool slide, wherein the tool slide is supported by a tool holder such that it can be displaced horizontally by means of a guide piston. It is a disadvantage of this solution, however, that components with a relatively high mass overall have to be made to vibrate.

### SUMMARY

Taking this as the departure point, it is an object of the present invention to provide a method for machining a workpiece, a tool head and a lathe which simplify the production of, for example, smooth planar or cylindrical surfaces and by means of which the aforementioned disadvantages can be reduced or even avoided altogether.

In respect of the method defined in the introduction, this object is achieved by the use of one or more features of the invention and, in particular, in that the oscillating additional movement of the cutting edge of the machining tool is an oscillating pivoting movement about at least one pivot axis. The oscillating additional movement of the cutting edge means that unevennesses, such as indentations, grooves or also protrusions, which may possibly be present on the at least one cutting edge of the machining tool come into contact with different regions, in particular with different axial regions, of the workpiece. It is thus possible for the unevennesses of the cutting edge, which transfer to the workpiece surface while the workpiece is being turned, to be balanced out with the aid of the oscillating additional movement of the cutting edge. This makes it possible to produce a particularly smooth, and largely also twist-free or helix-free, surface on the workpiece.

In the case of the previously designed method, provision may additionally be made for the advancement movement of the machining tool to comprise at least one movement component which corresponds to an oscillating pivoting movement of the machining tool about a pivot axis, in particular about a pivot axis of a tool head. This oscillating pivoting-movement component of the advancement movement can take place here about a pivot axis which is oriented transversely, at right angles or optionally also parallel to an axis of rotation of the workpiece. This makes it possible to create a method for machining a workpiece in the case of which an oscillating pivoting movement of the machining tool is accompanied by an oscillating additional pivoting movement, so that particularly fine surfaces with only small roughness depths are produced.

However, it is also possible for the advancement movement of the machining tool to comprise at least one movement component which corresponds to a linear movement of the machining tool in a plane which is parallel or at right angles to, or oblique in relation to, the axis of rotation of the workpiece.

It may be expedient if at least one pivot axis of the oscillating additional movement of the cutting edge of the machining tool is oriented transversely or at right angles to the axis of rotation of the workpiece. In addition, or also as an alternative, to this, provision may also be made for at least one pivot axis, in particular a second pivot axis, of the oscillating additional movement of the cutting edge of the machining tool to be oriented parallel to the axis of rotation of the workpiece. A largely twist-free workpiece surface can be produced in particular when the oscillating additional movement of the cutting edge of the machining tool is oriented transversely or at right angles to the axis of rotation of the workpiece and preferably the advancement movement of the machining tool comprises a movement component which corresponds to an oscillating pivoting movement of the machining tool about a pivot axis which is oriented parallel to an axis of rotation of the workpiece. It should be pointed out that it may be particularly advantageous here if the at least one cutting edge of the machining tool describes a helix.

In respect of the tool head defined in the introduction for a lathe, having a tool holder retaining a machining tool, in particular one with at least one cutting edge, the previously mentioned object is achieved by the means and features of claim 4 and, in particular, in that the tool head has at least one actuator, which is intended for generating an additional movement of the tool holder in the form of an oscillating pivoting moment about at least one pivot axis. This additional movement can then be accompanied by an actual advancement movement of the machining tool.

The present invention is based on the finding that the oscillating pivoting of the machining tool with its cutting edge, or the tool holder, during the advancement movement of the tool relative to the workpiece which is to be machined can produce planar surfaces with a low level of surface roughness. It is possible here for an oscillation of the machining tool with its cutting edge, or the tool holder which retains the machining tool with its cutting edge, through relatively small turning angles to be sufficient to produce satisfactory surface qualities.

A further advantage of the tool head according to the invention, in particular in relation to the apparatus already known from German Utility Model 203 03 204 U1, can be seen in the fact that, here, only relatively small masses have to be made to execute an oscillating pivoting movement.

This has a positive effect overall on the power required by the lathe and allows the tool head to be of compact construction. In addition, the tool head according to the invention makes it possible for the components provided for generating the oscillating pivoting movement of the tool holder and of the cutting edge to be integrated in the tool head.

The tool head, in addition, can be configured, or intended, for releasable attachment to a tool turret of an existing lathe. This means that existing lathes can easily be retrofitted with a tool head according to the invention.

In one configuration of the tool head according to the invention, the at least one actuator can be designed to generate an oscillating linear displacement movement, wherein the tool head may then expediently have a device for converting the oscillating linear displacement movement into the oscillating pivoting movement of the tool holder. Actuators for generating a linear displacement movement have an advantageous construction, and therefore this configuration of the tool head according to the invention allows a compact design of the tool head and/or of a housing of the tool head.

The at least one actuator for generating an oscillating linear displacement movement can advantageously be arranged here such that the oscillating linear displacement movement takes place along a spatial axis or in a direction which is oriented transversely or at right angles to the at least one pivot axis of the tool holder. This configuration of the tool head according to the invention can provide for a particularly compact construction of the tool head and/or the housing thereof.

In the case of one configuration of the tool head, provision may be made for the device for converting the oscillating linear displacement movement into the oscillating pivoting movement to be formed by a flexible coupling. It is possible for this flexible coupling, at a first end, to be connected to a driven element, in particular a push rod, of the at least one actuator and, at a second end, which is arranged in particular opposite the aforementioned first end, to be connected to the tool holder. The flexible coupling here can be spaced apart, in particular radially, from the pivot axis of the tool holder.

Such a coupling can realize a robust and durable attachment of the actuator to the tool holder, which is arranged transversely to the actuator, it being possible, in addition, for said attachment to be established in an advantageous manner. However, it is also conceivable, in principle, for the at least one actuator provided to be one which generates an oscillating pivoting movement and transmits the latter directly to the tool holder. It is possible here for the tool holder then to be connected to the actuator such that a pivoting movement of the actuator results in a pivoting movement of the tool holder.

When the tool head is in the use position on a lathe, it is possible, depending on the application, for the at least one pivot axis of the oscillating pivoting movement of the tool holder to be oriented transversely or at right angles or also parallel to an axis of rotation of an operating spindle of the lathe in order to drive a workpiece which is to be machined. In particular if, in the use position of the tool head, the at least one pivot axis of the oscillating pivoting movement of the tool holder is oriented transversely or at right angles to an axis of rotation of an operating spindle of the lathe in order to drive a workpiece which is to be machined, any unevennesses present on the cutting edge of the machining tool can be compensated for, or balanced out, while the workpiece is being turned. This can take place in that—as a result of the oscillating pivoting movement of the tool holder about a pivot axis oriented transversely or at right angles to the axis of rotation of the operating spindle—any unevennesses formed on the cutting edge come into contact with different axial regions of the workpiece, and therefore these unevennesses are balanced out on the workpiece and it is possible to produce a smooth surface with only a small roughness depth.

In other words, when the tool head is in the use position on a lathe, it is possible for the first pivot axis to be oriented transversely or at right angles to an axis of rotation of an operating spindle of the lathe and/or for the second pivot axis to be oriented parallel to the axis of rotation of the operating spindle of the lathe.

Particularly flexible machining and production of particularly low-twist or even twist-free surfaces can be realized if the pivoting movement of the tool holder comprises a first pivoting-movement component about a first pivot axis and a second pivoting-movement component about a second pivot axis. It is possible here for the first pivot axis to be oriented transversely or at right angles to the second pivot axis. This creates a tool head in the case of which an advancement movement of the machining tool relative to the workpiece can be accompanied by an additional movement which corresponds to a pivoting movement of the machining tool about a first pivot axis and a pivoting movement about a second pivot axis. This can further improve the quality of the machined surface of the workpiece. It is additionally possible in this way to create a tool head in the case of which the direction of the oscillating pivoting movement of the machining tool can be freely selected. It is thus conceivable for the machining tool to be pivoted about the one pivot axis during one machining step and for the machining tool to be pivoted about the other pivot axis during a following machining step, this providing for an additional movement to accompany the advancement movement.

Provision may also be made for the tool head also to be capable of being pivoted in oscillation about a pivot axis which is oriented transversely or at right angles or also parallel to the at least one pivot axis of the tool holder. When it is in its use position on a lathe, the tool head can then be pivoted about a pivot axis which is oriented transversely or at right angles or parallel to an axis of rotation of an operating spindle of the lathe for a workpiece which is to be machined. Also conceivable, in principle, is the situation where, when it is in its use position on the lathe, the tool head can be displaced in a plane which is parallel or also at right angles to, or oblique in relation to, the axis of rotation of the operating spindle. This means that a wide variety of different advancement movements for machining a workpiece can be carried out with the aid of the tool head.

All the advancement movements described above can then be accompanied by the above-described additional movements which are carried out by the oscillating pivoting movement of the tool holder together with the machining tool and the cutting edge formed on the machining tool.

The oscillating pivoting movement of the tool holder can correspond to an oscillating rotation or pivoting movement of the tool holder through less than 10°, preferably through 5°, in both turning directions. In the case of a particularly fine and/or high-frequency oscillating pivoting movement, it is quite conceivable for the oscillating pivoting movement of the tool holder to correspond to an oscillating rotation of the tool holder through less than 1° in both turning directions.

In other words, even a relatively small oscillating rotation or pivoting movement of the tool is sufficient to produce the desired smoothing of the machined surfaces. A correspondingly small displacement movement of the actuator is necessary for such a pivoting movement, as a result of which the power consumption can be reduced to a considerable extent in relation to apparatuses from the prior art.

It should be mentioned here that the oscillation frequency of the oscillating pivoting movement of the tool holder may be greater than a turning frequency, relative to the machining tool, of a workpiece which is to be machined. This aids the production of particularly smooth surfaces.

It is also worth mentioning that the oscillation frequency of the oscillating pivoting movement of the tool holder may be greater than an oscillation frequency of a, for example of the above-described, pivoting movement of the tool head about its pivot axis.

Particularly uniform surfaces can be produced if the oscillation frequency of the oscillating pivoting movement of the tool holder can be, or is, coordinated with the turning frequency, relative to the machining tool, of a workpiece which is to be machined.

The tool head according to the invention can have a particularly low-level power requirement if the at least one actuator is formed by a piezoelectric actuator. This is because piezoelectric actuators are distinguished by a particularly low-level power requirement.

The tool head can be fastened in a releasable manner on a tool turret of a lathe. Provision may be made, in particular, for the tool head to have a releasable coupling, which can be designed preferably in the form of a plug-in coupling for connecting the tool head to a tool turret of a lathe. This type of coupling provides for particularly straightforward, possibly standardized attachment of the tool head to the tool turret of an existing lathe. It is thus possible to create a tool head with which existing lathes can be retrofitted particularly easily.

The at least one actuator of the tool head according to the invention here can be supplied with energy, in particular with power, directly from the outside, for example via an energy-supply line or a power line. It is also conceivable, however, for the actuator to be supplied with energy via an energy-supply line and/or power line which runs within the tool head, and can be connected to a corresponding connection point on the tool turret.

It should be mentioned here that the cutting edge of the machining tool itself can have a curved progression, in particular a helical progression. In particular in combination with the oscillating pivoting movement of the tool holder, this can aid particularly low-twist or even twist-free machining of a surface.

The cutting edge of the machining tool here can be in the form of a helix which is coaxial in relation to a, for example the already aforementioned, pivot axis of the tool head. This helix can have a pitch with a pitch angle between 0° and 90°, preferably between 15° and 45°. The pitch angle of this helix can also be positive or negative in relation to a direction of the advancement movement of the machining tool.

In respect of the lathe defined in the introduction, the aforementioned object is achieved by one or more features of the invention and, in particular, in that the at least one tool head fitted on the tool turret is a tool head. It is thus possible to provide a lathe which has a plurality of tool heads with different machining tools even for the face turning of workpiece surfaces, wherein each of the tool heads can be designed in order for a surface with low levels of surface roughness to be produced by means of the described oscillating pivoting movement of the respective machining tool.

It may be expedient, for this purpose, if the lathe, in particular the tool turret, is intended for generating a relative movement between the at least one tool head and the workpiece which is to be machined. This relative movement, which may also be referred to as an advancement movement, can correspond to an oscillating pivoting movement of the tool head about a pivot axis which is oriented transversely or at right angles or also parallel to the axis of rotation of the operating spindle and thus also of the workpiece. It is also possible, however, for this relative movement to correspond to a linear advancement movement in a plane which is parallel or at right angles to, or oblique in relation to, the axis of rotation of the operating spindle and of the workpiece. It is also possible, in principle, for the above-described head-pivoting movement of the tool to be combined with the linear advancement movement in a plane which is parallel or at right angles, or oblique in relation to, the axis of rotation of the operating spindle and of the workpiece.

It is therefore possible to create a lathe which is intended for implementing the method as provided herein.

### BRIEF DESCRIPTION OF THE DRAWINGS

An exemplary embodiment of the invention will be described herein-below with reference to the drawings, in which, in in some cases highly schematic illustrations:

FIG. 1 shows a perspective view of a tool head according to the invention,

FIG. 2 shows a side view of the tool head illustrated in FIG. 1,

FIG. 3 shows a side view of the tool head according to the invention illustrated in FIGS. 1 and 2, this side view being taken in section along section line A to A depicted in FIG. 2, and

FIG. 4 shows a highly schematic illustration of an embodiment of a lathe according to the invention in order to depict the relative positions of the pivot axes of the machining tool and of the tool holder, of the pivot axis of the tool head and of the axes of rotation of the workpiece and of the operating spindle.

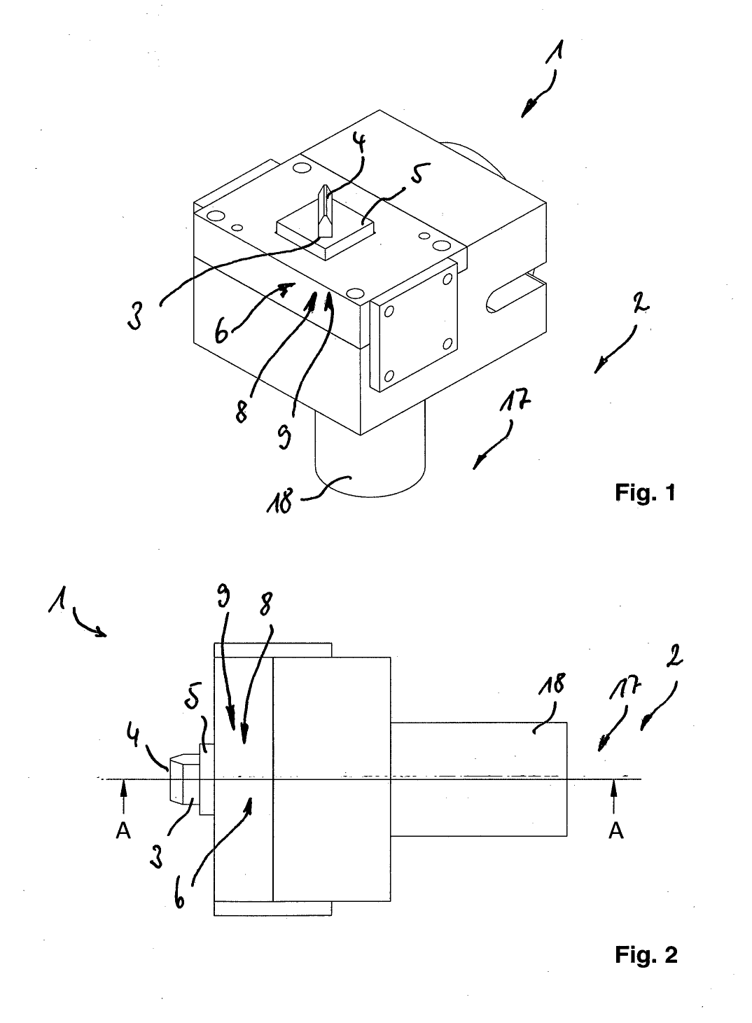

### DETAILED DESCRIPTION

All the figures show a tool head which is designated as a whole by 1 and is intended for a lathe 2, which is illustrated only in highly schematic fashion in FIG. 4. The tool head 1 is provided with a machining tool 3, which has a cutting edge 4. The machining tool 3 is retained by a tool holder 5 of the tool head 1. The tool head 1 has an actuator 6, which is intended for generating a movement, more precisely an additional movement, in the form of an oscillating pivoting movement of the tool holder 5 about a pivot axis 7.

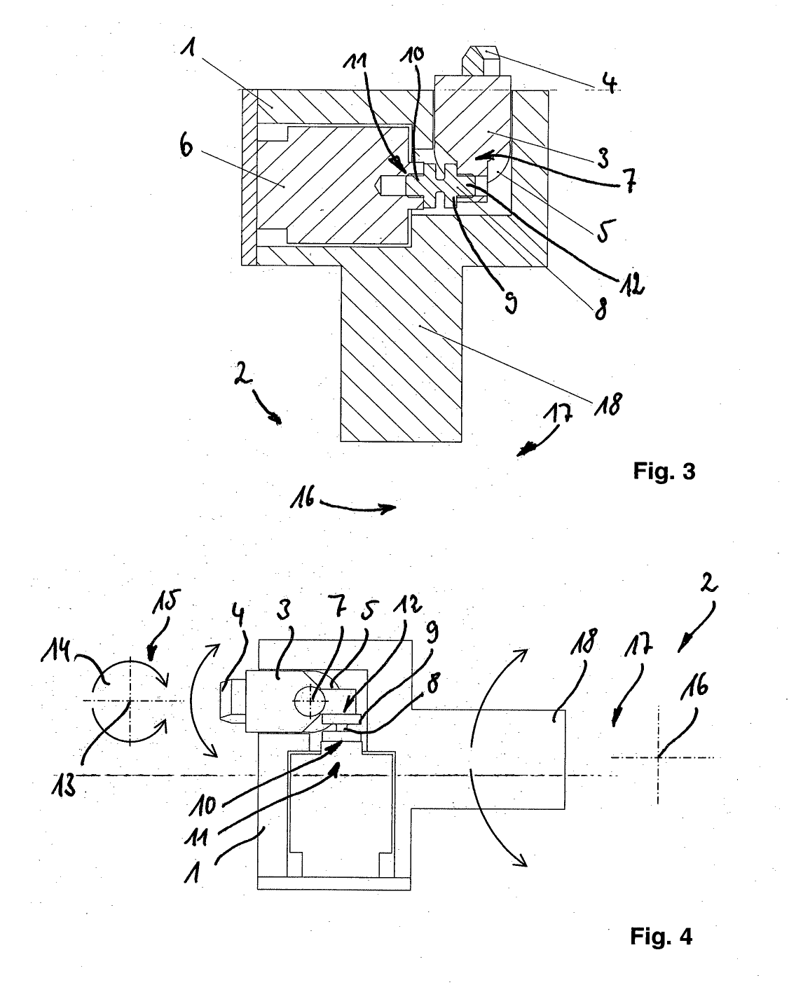

It is clear from FIG. 3 that the actuator 6 is designed for generating an oscillating linear displacement movement, and that the tool head 1 has a device 8 for converting this oscillating linear displacement movement into the oscillating pivoting movement of the tool holder 5. According to FIGS. 3 and 4, the actuator 6 for generating the oscillating linear displacement movement is arranged such that the oscillating linear displacement movement takes place along a spatial axis or in a direction which is arranged transversely, and in the present exemplary embodiment of the tool head 1 according to the invention even at right angles, to the pivot axis 7 of the tool holder 5.

The device 8 for converting the oscillating linear displacement movement into the oscillating pivoting movement is formed by a flexible coupling 9. This flexible coupling 9, at a first end 10, is connected to a driven element 11, for example a push rod, of the actuator 6 and, at a second end 12, which is arranged opposite the first end 10, is connected to the tool holder 5. The flexible coupling 9 here is at a radial spacing from the pivot axis 7 of the tool holder 5.

When the tool head 1 is in the use position on the lathe 2, as illustrated in FIG. 4, the pivot axis 7 of the oscillating pivoting movement of the tool holder 5 is oriented parallel to an axis of rotation 13 of an operating spindle 14, which can drive a workpiece 15 which is to be machined. It should be pointed out here that the axis of rotation 13 of the operating spindle 14 coincides with the axis of rotation of the workpiece 15.

In the case of that exemplary embodiment of the tool head 1 according to the invention which is illustrated in the figures, the pivoting movement of the tool holder 5 comprises merely a pivoting-movement component which takes place about the already above-described pivot axis 7. In the case of another exemplary embodiment of the tool head 1 according to the invention, which is not illustrated in the figures, this pivoting movement can comprise a first pivoting-movement component about a first pivot axis and a second pivoting-movement component about a second pivot axis. The first pivot axis here is oriented transversely or at right angles to the second pivot axis.

It is clear in particular from the illustration of the tool head 1 according to the invention in FIG. 4 that the tool head 1 can also be pivoted in oscillation about a pivot axis 16. In the case of the exemplary embodiment of the invention which is illustrated in FIG. 4, this pivot axis 16 is oriented parallel to the pivot axis 7 of the tool holder 5 and also parallel to the axis of rotation 13 of the operating spindle 14 of the lathe 2. In the case of another exemplary embodiment of the invention, which is not illustrated in the figures, provision is made for the tool head 1 to be pivotable in oscillation about a pivot axis which is oriented transversely or at right angles to the pivot axis 7 of the tool holder 5. It is then possible for the pivot axis 16 of the tool head 1 to be oriented optionally transversely or at right angles or parallel to the axis of rotation 13 of the operating spindle 14 of the lathe 2 for the workpiece 15 which is to be machined. In addition, or as an alternative, to this, it is possible, when it is in its use position on the lathe 2, for the tool head 1 to be displaceable in a plane which is parallel or also at right angles to, or oblique in relation to, the axis of rotation 13 of the operating spindle 14. This makes it possible to predetermine a wide variety of different advancement movements for machining the workpiece 15.

The oscillating pivoting movement of the tool holder can correspond to an oscillating rotation or pivoting movement of the tool holder 5 through less than 10°, preferably through 5°, in particular through less than 1°, in both turning directions or pivoting directions.

The oscillation frequency of the oscillating pivoting movement of the tool holder 5 here is greater than a turning frequency, relative to the machining tool 3, of the workpiece 15 which is to be machined. The oscillation frequency of the oscillating pivoting moment of the tool holder 5 is also greater than an oscillation frequency of the pivoting movement of the tool head 1 about its pivot axis 16.

The oscillation frequency of the oscillating pivoting movement of the tool holder 5 can be coordinated with the turning frequency, relative to the machining tool 3, of the workpiece 15 which is to be machined.

The actuator 6 of the tool head 1 is formed by a piezoelectric actuator. Such an actuator is distinguished by its low-level energy requirement.

The tool head 1 can be fastened in a releasable manner on a tool turret 17 of the lathe 2. For this purpose, the tool head 1 has a releasable coupling 18, which is designed in the form of a plug-in coupling and by means of which the tool head 1 can be connected in a releasable manner to the tool turret 17 of the lathe 2. In the case of an exemplary embodiment of the tool head 1 according to the invention which is not illustrated in the figures, the cutting edge 4 of the machining tool 3 is in the form of a helix. It is possible for the latter to be coaxial in relation to the pivot axis 16 of the tool head 1 and to have a pitch with a pitch angle between 0° and 90°, preferably between 15° and 45°.

In addition to the at least one tool head 1 according to the invention, the lathe 2 can accommodate further tool heads 1 according to the invention, or else also other tool heads, on its tool turret 17.

The lathe 2 may also be intended for generating a relative movement between the at least one tool head 1 according to the invention and the workpiece 15. This relative movement, which is responsible at least for part of the advancement movement for the purpose of turning the workpiece 15, corresponds to the oscillating pivoting movement of the tool head 1 about the pivot axis 16, which is oriented transversely, at right angles or also parallel to the axis of rotation 13 of the operating spindle 14 and of the workpiece 15. In addition, it is possible for the lathe 2, and in particular the tool turret 17 of the lathe 2, also to be intended for carrying out a linear advancement movement in a plane which is oblique in relation to, or parallel or at right angles to, the axis of rotation 13 of the operating spindle 14 and of the workpiece 15.

The lathe 2 is intended for implementing the method described herein-below for machining the workpiece 15 with the aid of the material-removing machining tool 3 having at least one cutting edge 4:

The workpiece 15 here is driven in rotation in order to generate a cutting movement, with the aid of the operating spindle 14 of the lathe 2, and the cutting edge 4 of the machining tool 3 is brought into cutting engagement with the workpiece 15. In addition, the machining tool 3 is moved by a defined advancement movement relative to the workpiece 15. The advancement movement is then accompanied by an oscillating additional movement of the cutting edge 4 of the machining tool 3. The oscillating additional movement of the cutting edge 4 of the machining tool 3 here is an oscillating pivoting movement about the pivot axis 7.

The advancement movement of the machining tool 3 comprises a movement component which corresponds to an oscillating pivoting movement of the machining tool 3 about a pivot axis, in this case about the pivot axis 16 of the tool head. In the exemplary embodiment illustrated in the figures, this pivot axis 16 is oriented parallel to the axis of rotation 13 of the workpiece 15 and of the operating spindle 14 of the lathe 2. Depending on requirements, it is also possible for the advancement movement of the machining tool 3 to comprise at least one movement component which corresponds to a liner movement of the machining tool 3 in a plane which is parallel or at right angles to, or oblique in relation to, the axis of rotation 13 of the workpiece 15 and of the operating spindle 14. As already described in detail above, the pivot axis 7 of the oscillating additional movement of the cutting edge 4 of the machining tool 3 can be oriented transversely or at right angles or also parallel to the axis of rotation 13 of the workpiece 15 and of the operating spindle 14.

The invention proposes, in addition to a method for machining the workpiece 15 and to the lathe 2, in particular also the tool head 1 for the lathe 2, having the tool holder 5 retaining the machining tool 3, wherein the tool head 1 has the at least one actuator 6 for generating the additional movement of the tool holder 5 in the form of an oscillating pivoting movement about the at least one pivot axis 7.

### LIST OF REFERENCE SIGNS

1 Tool head

2 Lathe

3 Machining tool

4 Cutting edge

5 Tool holder

6 Actuator

7 Pivot axis of 5

8 Device for converting the oscillating linear displacement movement into the oscillating pivoting movement

9 Flexible coupling

10 First end of 9

11 Driven element

12 Second end of 9

13 Axis of rotation of 14/15

14 Operating spindle

15 Workpiece

16 Pivot axis of the tool head

17 Tool turret

18 Coupling of the tool head

1. A method for machining a workpiece (15), comprising:
providing a material-removing machining tool (3) having at least one cutting edge (4),
driving the workpiece (15) in rotation in order to generate a cutting movement,
bringing the cutting edge (4) of the machining tool (3) into cutting engagement with the workpiece (15) by an advancement movement that includes an oscillating additional movement of the cutting edge (4) of the machining tool (3), and the oscillating additional movement of the cutting edge (4) of the machining tool (3) is an oscillating pivoting movement about at least one pivot axis (7).

2. The method as claimed in claim 1, wherein the advancement movement of the machining tool (3) comprises at least one of (i) a movement component which corresponds to an oscillating pivoting movement of the machining tool (3) about a pivot axis, said pivot axis being transverse or at right angles or parallel to an axis of rotation (13) of the workpiece (15), or (ii) at least one movement component which corresponds to a liner movement of the machining tool (3) in a plane which is parallel or at right angles to, or oblique in relation to, the axis of rotation (13) of the workpiece (15).

3. The method as claimed in claim 1, wherein the at least one pivot axis (7) of the oscillating additional movement of the cutting edge (4) of the machining tool (3) is oriented transversely or at right angles or parallel to the axis of rotation (13) of the workpiece (15).

4. A tool head (1) for a lathe (2), comprising
a tool holder (5) retaining a machining tool (3),
at least one actuator (6) that generates an additional movement of the tool holder (5) in the form of an oscillating pivoting movement about at least one pivot axis (7).

5. The tool head (1) as claimed in claim 4, wherein the at least one actuator (6) is configured to generate an oscillating linear displacement movement, and wherein the tool head (1) further comprises a device (8) that converts the oscillating linear displacement movement into the oscillating pivoting movement of the tool holder (5).

6. The tool head (1) as claimed in claim 5, wherein the at least one actuator (6) for generating the oscillating linear displacement movement is arranged such that the oscillating linear displacement movement takes place along a spatial axis or in a direction which is arranged transversely or at right angles to the at least one pivot axis (7) of the tool holder (5).

7. The tool head (1) as claimed in claim 5, wherein the device (8) for converting the oscillating linear displacement movement into the oscillating pivoting movement includes a flexible coupling (9) having a first end (10) that is connected to a driven element (11) of the at least one actuator (6) and a second end (12) arranged opposite the first end that is connected to the tool holder (5).

8. The tool head (1) as claimed in claim 4, wherein, when the tool head (1) is in a use position on a lathe (2), the at least one pivot axis (7) of the oscillating pivoting movement of the tool holder (5) is adapted to be oriented transversely or at right angles or parallel to an axis of rotation (13) of an operating spindle (14) of the lathe (2) in order to drive a workpiece (15) which is to be machined.

9. The tool head (1) as claimed in claim 4, wherein the pivoting movement of the tool holder (5) comprises a first pivoting-movement component about a first pivot axis (7) and a second pivoting-movement component about a second pivot axis, and the first pivot axis is oriented transversely or at right angles to the second pivot axis.

10. The tool head (1) as claimed in claim 4, wherein the tool head (1) is pivotable in oscillation about a pivot axis (16) which is oriented transversely or at right angles or parallel to the at least one pivot axis (7) of the tool holder (5), or, when in a use position on a lathe (2), the tool head (1) can be pivoted about a pivot axis (16) which is oriented transversely or at right angles or parallel to an axis of rotation (13) of an operating spindle (14) of the lathe (2) for a workpiece (15) which is to be machined, or in the use position on the lathe (2), the tool head (1) is displaceable in a plane which is parallel or at right angles to, or oblique in relation to, the axis of rotation (13) of the operating spindle (14).

11. The tool head (1) as claimed in claim 4, wherein the oscillating pivoting movement of the tool holder (5) corresponds to an oscillating rotation or pivoting movement of the tool holder (5) through less than 10 degrees in both turning directions.

12. The tool head (1) as claimed in claim 4, wherein an oscillation frequency of the oscillating pivoting movement of the tool holder (5) is greater than a turning frequency, relative to the machining tool (3), of a workpiece (15) which is to be machined, or the oscillation frequency of the oscillating pivoting movement of the tool holder (5) is greater than an oscillation frequency of the pivoting movement of the tool head (1) about a pivot axis (16) thereof.

13. The tool head (1) as claimed in claim 4, wherein an oscillation frequency of the oscillating pivoting movement of the tool holder (5) is coordinated with a turning frequency, relative to the machining tool (3), of a workpiece (15) which is to be machined.

14. The tool head (1) as claimed in claim 4, wherein the at least one actuator (6) comprises a piezoelectric actuator.

15. The tool head (1) as claimed in claim 4, wherein the tool head (1) is releasably fastenable on a tool turret (17) of a lathe (2) using a releasable coupling (18) of the tool head (1).

16. The tool head (1) as claimed in claim 4, wherein the cutting edge (4) of the machining tool (3) has a helix form which is coaxial in relation to a pivot axis (16) of the tool head (1).

17. A lathe (2) having an operating spindle (14) for driving in rotation a workpiece (15) which is to be machined by turning, having a tool turret (17), and having at least one tool head (1) as claimed in claim 4 fitted on the tool turret (17).

18. The lathe (2) as claimed in claim 17, wherein the tool turret (17) generates a relative movement between the at least one tool head (1) and the workpiece (15), the relative movement corresponds to at least one of an oscillating pivoting movement of the tool head (1) about a pivot axis (16) which is oriented transversely or at right angles or parallel to the axis of rotation (13) of the operating spindle (14) and of the workpiece (15), or corresponds to a linear advancement movement in a plane which is oblique in relation to, or parallel or at right angles to, the axis of rotation (13) of the operating spindle (14) and of the workpiece (15).

19. A method for machining a workpiece (15) using the lathe according to claim 17, the method comprising:
driving the workpiece (15) in rotation in order to generate a cutting movement,
bringing the cutting edge (4) of the machining tool (3) into cutting engagement with the workpiece (15) by an advancement movement that includes an oscillating additional movement of the cutting edge (4) of the machining tool (3), and the oscillating additional movement of the cutting edge (4) of the machining tool (3) is an oscillating pivoting movement about at least one pivot axis (7).
